(19) United States
(12) Patent Application Publication
(10) Pub. No.: US 2020/0220260 A1
(43) Pub. Date: Jul. 9, 2020

(54) ACTUATOR ASSEMBLY FOR BASE STATION ANTENNA

(71) Applicant: CommScope Technologies LLC, Hickory, NC (US)

(72) Inventors: ManKun Li, Suzhou (CN); XiaoYan Wang, Suzhou (CN); ZhaoHui Liu, Suzhou (CN); Junfeng Yu, Suzhou (CN)

(21) Appl. No.: 16/705,752

(22) Filed: Dec. 6, 2019

(30) Foreign Application Priority Data
Jan. 4, 2019 (CN) 201910005935.1

(51) Int. Cl. H01Q 3/08; H01Q 1/24

(52) U.S. Cl. CPC H01Q 3/08; H01Q 1/246

(57) ABSTRACT

The present invention relates to an actuator assembly for a base station antenna. The actuator assembly includes a plurality of actuators mounted side by side, a drive shaft, a drive gear configured to be axially movable relative to the drive shaft, and a moving device configured to axially move the drive gear relative to the drive shaft. Each actuator has a driven gear and an actuator element that is in transmission connection with the driven gear. The drive gear is configured for axial movement relative to the drive shaft, so as to engage with or disengage from the driven gear of any one of the actuators and configured to drive the one driven gear in engagement with the drive gear. The actuator assembly has a simple structure, a low height, a favorable PIM performance, and is expandable flexibly.

### CROSS-REFERENCE TO RELATED APPLICATION

The present application claims priority from and the benefit of Chinese Patent Application No. 201910005935.1, filed Jan. 4, 2019, the disclosure of which is hereby incorporated herein in its entirety.

### FIELD

The present invention relates to the field of wireless communication, and more specifically to an actuator assembly for a base station antenna.

### BACKGROUND

The mobile communication network comprises a large number of base stations, each of which may include one or more base station antennas for receiving and transmitting radio frequency signals. A single base station antenna may include many radiator assemblies, which are also referred to as antenna elements or radiating elements. While cellular operators are now requesting base station antennas that operate in two, three or more frequency-bands, they expect little or no increase in the size of the base station antennas. Thus, there is an increasing challenge in designing base station antennas that meet both the functional and size requirements specified by cellular operators.

The cost of a radome may be a significant part of the total cost of a base station antenna. Thus, the smaller the size of the radome, the lower the cost of the base station antenna. Many base station antennas include a plurality of actuators that are configured to adjust the base station antenna. For example, an actuator may be used to adjust one or more phase shifters that are included in the antenna in order to electrically adjust the elevation or “tilt” angles of one or more of the antenna beams formed by the base station antenna. Actuators may be used to adjust various other characteristics of a base station antenna, including the azimuth angles, the beam widths, and/or the power distribution of the antenna beams, and even the physical orientation of the radiating elements of the base station antenna. Actuator assemblies having flat designs may facilitate reducing the size of the base station antenna, and hence the size of the radome.

Metal components in a base station antenna can increase uncertainty in the performance of the antenna, particularly in terms of passive intermodulation (PIM), return loss, and isolation performance. Shielding measures may be taken to reduce the effects of the metal components. However, metal components that move within the antenna may be more complicated and difficult to adequately shield.

PCT Publication WO2016/137567A1 discloses an actuator assembly for a base station antenna that comprises a drive motor, a plurality of RET (Remote Electrical Tilt) actuators, and a lead screw transmission that allows the drive motor to selectively engage with and disengage from the RET actuators. The drive motor is configured to move reciprocally along an axis. The movement of the drive motor and an associated cable connected thereto may have an adverse effect on the performance of the base station antenna. In addition, the engagement and disengagement process of a drive gear mounted on a drive shaft of the drive motor and the driven gears of the RET actuators require complicated control of the drive motor, where the drive motor needs to perform both a linear movement and a rotational movement cooperating with the linear movement.

Chinese utility model document CN207634638U discloses an actuator assembly for a base station antenna that comprises a drive motor, a shift motor, a shifter driven by the shift motor, and a plurality of actuators, wherein each of the actuators is provided with a clutch that includes a drive element and a driven element. The driver motor drives the drive elements of all the clutches simultaneously, with one of the actuators functioning when one of the clutches is engaged by the shifter. This actuator assembly has a large number of parts, a complex structure, and high energy consumption during operation.

### SUMMARY

It is an object of the present invention to provide an actuator assembly for a base station antenna in a simple structure, whereby it is possible to overcome at least one of the defects in the prior art.

To this end, there is proposed an actuator assembly for a base station antenna, including: a plurality of actuators, a rotatably mounted drive shaft, and a drive gear configured to be axially movable relative to the drive shaft in order to engage with a selected one of the actuators.

In this actuator assembly, there may be less position-varying members during operation. This may be advantageous for the performance of the base station antenna.

In some embodiments, each actuator may include a driven rack and an actuator element, wherein the drive gear is configured to drive a selected one of the racks that is engaged with the drive gear.

In some embodiments, each actuator may include a driven gear and an actuator element that is in transmission connection with the driven gear, and the drive gear is configured to drive a selected one of the driven gears that is engaged with the drive gear.

In some embodiments, the drive gear and the driven gears may be spur gears, for example straight-toothed spur gears.

In some embodiments, the actuator assembly may further include a moving device configured to axially move the drive gear relative to the drive shaft.

In some embodiments, there is proposed an actuator assembly for a base station antenna, which includes: a plurality of actuators mounted side by side, a rotatably mounted drive shaft, a drive spur gear configured to be axially movable relative to the drive shaft, and a moving device configured to axially move the drive spur gear relative to the drive shaft. Each actuator has a driven spur gear and an actuator element in transmission connection with the driven spur gear or each actuator has a driven rack, which has an actuator element or is connected with an actuator element. The drive spur gear is configured to move axially relative to the drive shaft so as to engage with or disengage from the driven spur gear or the rack of any one of the actuators. The drive spur gear is configured to drive the one driven spur gear or the rack that engages with the drive spur gear.

In this actuator assembly, the drive spur gear and the driven spur gear have a relatively easy engagement process and disengagement process.

In this actuator assembly, there may be less position-varying members during operation. It is possible that, besides the drive spur gear and the members for axially moving the drive spur gear as well as the actuator elements of the actuators, the other members may be members in constant positions. This may be advantageous for the performance of the entire base station antenna.

Additionally, the actuator assembly may form a flat structure that has a smaller height and thus the radome may correspondingly have a smaller size.

In some embodiments, the drive gear is mounted on the drive shaft in an axially movable manner.

In some embodiments, the drive gear is mounted on the drive shaft in an axially movable and rotation-fixed manner.

In some embodiments, the drive shaft has a non-circular cross section, and the drive gear has a mounting hole, which has a complementary non-circular cross section. Alternatively, the drive shaft may have a circular cross section and have a channel, and the drive gear may have a sliding member embedded into the channel.

In some embodiments, the drive spur gear and the driven spur gears may be straight-toothed spur gears. Thus, it is possible to particularly easily achieve engagement and disengagement of the drive spur gear and the driven spur gears. Alternatively, helical spur gears may also be used.

In some embodiments, the drive gear and the driven gears may have an engagement assistant structure.

In some embodiments, at least one of the drive gear and the driven gears may have at least one tooth, which has one or two end sections that taper outwardly along an axial direction, as the engagement assistant structure.

For example, it is possible that each of the teeth of the drive spur gear and each of the teeth of the driven spur gears may respectively have two end sections that taper outwardly along the axial direction. It is also possible that each of the teeth of the drive spur gear may have two end sections that taper outwardly along the axial direction, while only one tooth or several teeth of the driven spur gears may have on both sides an extension portion that tapers outwardly along the axial direction.

In some embodiments, the moving device may be configured as a lead screw transmission, including a lead screw that is rotatably mounted and a nut that engages with the lead screw and is translationally movable along the lead screw, wherein the nut is configured to move the drive gear axially relative to the drive shaft. Here, “axial movement” may be defined with reference to the axis of the drive shaft.

As an alternative to the lead screw transmission, a rack and pinion transmission or a traction element transmission may also be used.

In some embodiments, the lead screw of the lead screw transmission may have an axis that is parallel to an axis of the drive shaft. Therefore, a compact structure can be realized.

In some embodiments, the actuator assembly may further include a drive motor configured to drive the drive shaft, wherein the drive motor is mounted at a fixed position. Since the drive motor is fixed in position, it is possible to easily effectuate shielding the drive motor and the cable connected with the drive motor, which is particularly advantageous in terms of PIM performance.

In some embodiments, the drive motor may be a DC motor or a stepper motor.

In some embodiments, the actuator assembly may further include an index motor configured to drive the lead screw of the lead screw transmission, wherein the index motor is mounted at a fixed position. Since the index motor is fixed in position, it is possible to easily effectuate shielding the index motor and the cable connected with the index motor, which is particularly advantageous in terms of PIM performance.

In some embodiments, the index motor may be a DC motor or a stepper motor.

In some embodiments, the moving device may include a sliding carriage fixedly connected with the nut.

In some embodiments, the sliding carriage may have a fork portion configured to interact with both end sides of the drive gear.

In some embodiments, the sliding carriage may be provided with a linear guide.

In some embodiments, the linear guide may include a channel and a sliding member which is configured on the sliding carriage and slidable in the channel.

In some embodiments, the sliding carriage may include a sliding member which is slidable in a channel.

In some embodiments, the actuator assembly may include a position sensor configured to directly or indirectly determine an axial position of the drive gear relative to the drive shaft.

For example, when a stepper motor is used as the index motor, the stepper motor may be equipped with an encoder counter, and the number of steps of the stepper motor may reflect the axial position of the drive gear relative to the drive shaft.

In some embodiments, the position sensor may include two conductive film strips, a movable electrode member in contact with the two conductive film strips and two stationary electrode members respectively connected with one of the conductive film strips, wherein the movable electrode member follows an axial movement of the drive gear relative to the drive shaft. The resistance value between the two stationary electrode members may reflect the axial position of the drive gear relative to the drive shaft.

In some embodiments, the sliding carriage may have the electrode member.

In some embodiments, each actuator may be provided with a locking device shiftable between a locked state in which the actuator is fixed in place and an unlocked state in which the actuator is movable.

In principle, the locking device may act on any one of movable members of the actuators, but it is particularly preferred that the locking device may interact with the driven gears or the driven racks of the actuators.

In some embodiments, the locking device may include a claw which is configured to engage with a tooth section of the driven gear of a respective actuator, and biased towards its engagement position, wherein when the drive gear engages with a respective driven gear, the claw is moved from its engagement position to its disengagement position, and when the drive gear disengages from the respective driven gear, the claw returns to its engagement position.

In some embodiments, the sliding carriage may have a part interacted with the claw, wherein the part is configured to: move the claw from its engagement position to its disengagement position when the drive gear engages with the respective driven gear, and leave the claw so that the claw returns to its engagement position when the drive gear disengages from the respective driven gear.

In some embodiments, the locking device may include a return spring which biases the claw towards its engagement position. It is also possible that the claw and a spring leaf are constructed integrally, wherein the spring leaf serves as a return spring.

In some embodiments, each actuator may be constructed as a linear actuator, wherein the actuator element of the actuator moves in a linearly translatable manner. It is also possible that, the actuator is constructed as a rotary actuator, wherein the actuator element of the actuator is rotatable.

In some embodiments, each actuator may include a lead screw transmission, including a lead screw that is rotatably mounted and in transmission connection with the driven gear and a nut that is translationally movable in engagement with the lead screw and fixedly connected with the actuator element. The lead screw transmission may have relatively high transmission accuracy. Optionally, the lead screw of the lead screw transmission of the actuator may have a manipulating part at which the lead screw can be manually rotated. For example, the respective lead screw may be manually rotated by means of a wrench that engages with the manipulating part.

In some embodiments, the actuator may include a driven rack that can be directly driven by the drive gear. In general, the transmission accuracy of the rack and pinion transmission is lower than that of the lead screw transmission, but the structure may be simpler and the number of parts may be less.

In some embodiments, the lead screw of the lead screw transmission of the actuator may be in transmission connection with the driven gear by means of a pair of gears, for example bevel gears.

In some embodiments, each actuator may include a lead screw transmission, including a lead screw that is rotatably mounted and in transmission connection with the drive gear and a nut that is translationally movable in engagement with the lead screw and fixedly connected with the actuator element.

In some embodiments, the lead screw of the lead screw transmission of the actuator may have an axis orthogonal to an axis of the drive gear.

In some embodiments, the lead screw of the lead screw transmission of the actuator may have an axis orthogonal to an axis of the driven gear of the actuator.

In some embodiments, the actuator element of each actuator may be configured to couple with a wiper arm of a phase shifter assembly.

In some embodiments, all the driven gears may have axes that are coincident or staggered parallel to each other, and the axes of all the driven gears may be parallel to the axis of the drive shaft.

In some embodiments, all the actuators may be arranged in parallel with each other in one plane, whereby it is possible to implement an actuator assembly that is as flat as possible, in particular when the drive motor together with the associated drive shaft as well as the index motor together with the associated lead screw transmission are also arranged in the same plane.

Alternatively, all the actuators may also be arranged in parallel with each other in two planes, with the actuators in one of the planes staggered relative to the actuators in the other of the planes.

In some embodiments, the actuators may be constructed as RET actuators.

In some embodiments, the actuator assembly may further include a planar substrate, on which the drive shaft and the actuators are mounted.

In some embodiments, the actuator assembly may further include a planar substrate, on which the moving device, the drive shaft and the actuators are mounted.

In some embodiments, at least some members of the actuator assembly may be made of plastic. For example, the lead screw transmissions, the drive shaft, the drive gear, the driven gears, the sliding carriage, the bearings and the like may be made of plastic, for example, made of fiberglass reinforced plastic. Alternatively, a gear, such as the drive gear, which is subjected to a high load, may also be partially or completely made of metal.

It is also to be noted here that, various technical features mentioned in the present application, even if they are recited in different paragraphs in the description or described in different embodiments, may be combined with one another randomly, only if these combinations are technically feasible. All of these combinations are the technical contents recited in the present application.

### BRIEF DESCRIPTION OF THE DRAWINGS

Next, the present invention will be illustrated in more detail by way of the embodiments with reference to the accompanying drawings. The schematic drawings are briefly described as follows:

FIG. 1 is a perspective view of an actuator assembly in accordance with an embodiment of the present invention.

FIG. 2 is a perspective view of a sliding carriage of the actuator assembly according to FIG. 1 as well as an associated nut and a drive gear.

FIG. 3 is an enlarged partial perspective view of the actuator assembly according to FIG. 1.

FIG. 4 is a partial top view of the actuator assembly according to FIG. 1.

FIGS. 5A and 5B are two perspective views of a drive gear for an actuator assembly in accordance with an embodiment of the present invention.

FIG. 6 is a partial schematic view of an actuator assembly according to another embodiment of the present invention.

FIGS. 7A and 7B are exemplar schematic views of actuator arrangements.

### DETAILED DESCRIPTION

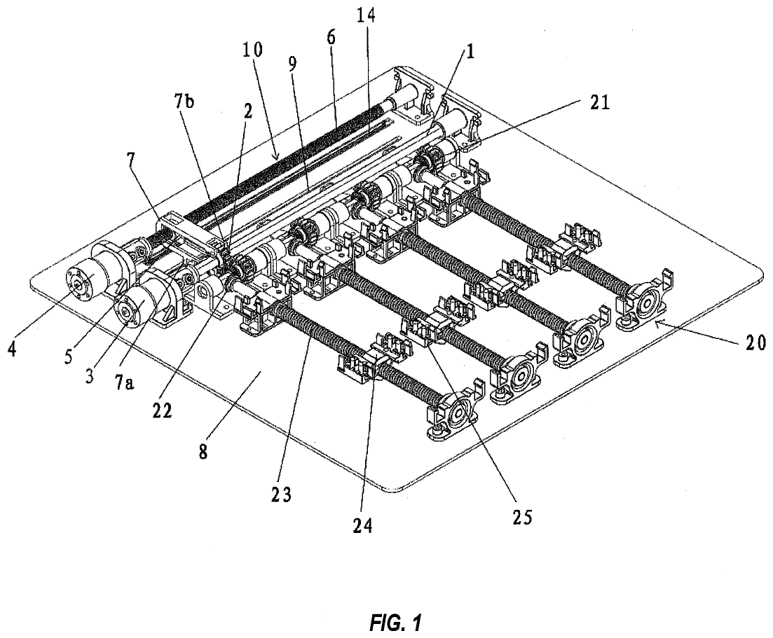

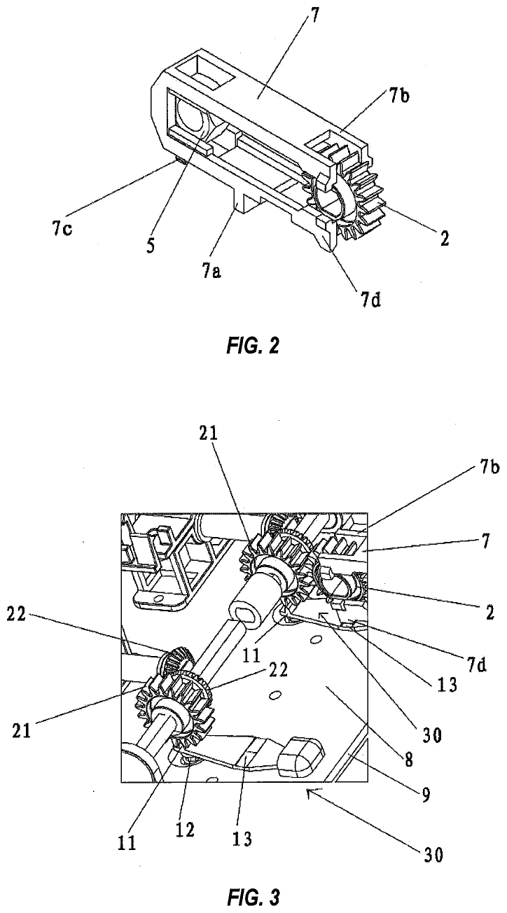

FIG. 1 is a perspective view of an actuator assembly in accordance with an embodiment of the present invention, and FIG. 2 is a perspective view of a sliding carriage of the actuator assembly according to FIG. 1 as well as an associated nut and a drive gear.

The actuator assembly comprises four actuators 20 that are mounted side by side in parallel in the same plane. The number of actuators 20 included in the actuator assembly may be selected according to actual needs. The number of the actuators 20 may be easily expanded. For example, six or eight actuators 20 may be provided simply by adding additional actuators 20 and lengthening a drive shaft 1 and a lead screw 6 (discussed below) of the actuator assembly.

Each actuator 20 may include a driven gear 21, which may be constructed as a spur gear, for example a straight-toothed spur gear, and an actuator element 25 that is in transmission connection with the driven gear 21. Here, each actuator 20 may include a lead screw transmission, including a lead screw 23 that is rotatably mounted and in transmission connection with the driven gear 21 and a nut 24 that is translationally movable in engagement with the lead screw 23 and fixedly connected with the actuator element 25. The fixed connection between the nut 24 and the actuator element 25 may be achieved, in some embodiments, by forming the nut 24 and the actuator element 25 as a single, integral element. The lead screw 23 may be in transmission connection with the driven gear 21 through a pair of gears 22 for example bevel gears in an example embodiment, and the longitudinal axis of the lead screw 23 may be at a 90 degree angle to the longitudinal axis of the driven gear 21. It will be appreciated, however, that the longitudinal axes of the lead screws 23 may also form other angles with the longitudinal axis of the respective driven gears 21, and the lead screws 23 may not be parallel to each other in some embodiments.

In other embodiments, each actuator 20 may include a rack in place of the driven gear 21, the pair of gears 22, the lead screw 23 and the nut 24. In such embodiments, the actuator element 25 may be fixedly connected to the rack.

The actuator element 25 of each actuator 20 may be, for example, coupled to a wiper arm of a phase shifter assembly (not shown) through a mechanical linkage (not shown). Characteristics of the antenna beam(s) formed by the radiating elements of the base station antenna, such as the azimuth and/or elevation angles of the antenna beam(s), may be adjusted by using electromechanical phase shifters to adjust the relative phases of the sub-components of RF signal(s) that are fed to the radiating elements. The actuators 20 may be used to adjust the electromechanical phase shifters in order to change the characteristics of the antenna beam(s).

As shown in FIG. 1, the actuators 20 are arranged in parallel in a common plane. It will be appreciated, however, that in other embodiments the actuators 20 may be arranged in parallel with each other in two planes, with the actuators 20 in one of the planes staggered relative to the actuators 20 in the other of the planes. The actuators 20 may be RET actuators. Regarding this, for example, reference may be made to the aforementioned international patent application document WO2016/137567A1. The axes of the driven gears 21 of the actuators 20 that are in the same plane may be coincident (as shown in FIG. 1), or may alternatively be staggered parallel to each other.

In the depicted embodiment, all of the actuators 20 function independently of each other. In other embodiments, two actuators 20 may function synchronously as a pair of actuators. In such embodiments, one of the two driven gears 21 may be omitted for the two actuators 20 of the pair, and the two actuators 20 in the pair can operate with a single driven gear 21.

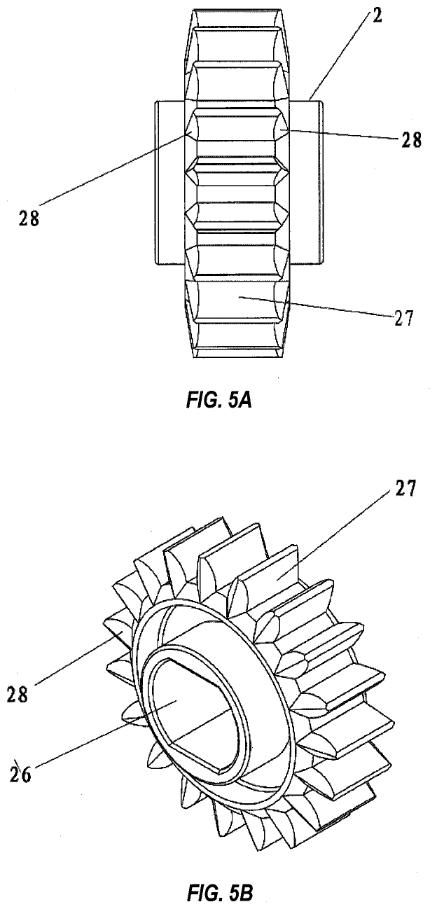

The actuator assembly as shown in FIG. 1 comprises a rotatably mounted drive shaft 1 (i.e., a drive shaft that is mounted so that it can rotate about its longitudinal axis) and a drive gear 2 that is mounted on the drive shaft 1 in an axially movable and rotation-fixed manner and may be constructed as a spur gear, for example a straight-toothed spur gear. Thus, the drive gear 2 is configured to move linearly along the drive shaft 1 in the longitudinal direction of the drive shaft 1, and is configured so that it will not rotate independently of the drive shaft 1. The drive shaft 1 has a non-circular cross section, and the drive gear 2 has a mounting hole 26 (see FIG. 5B) through which the drive gear 2 is sleeved on the drive shaft 1, where the mounting hole 26 has a complementary non-circular cross section to the non-circular cross section of the drive shaft 1. In other embodiments, the drive shaft 1 may have a circular cross section and have a channel, and the drive gear 2 may have a sliding member embedded in the channel.

In other embodiments, the drive gear 2 is rotatably mounted on the drive shaft 1 and is associated with a brake which, when activated, causes the drive gear 2 to be connected rotation-fixedly with the drive shaft 1. For example, the drive gear 2 as shown in FIG. 5B may be divided into an inner portion and an outer portion, which are supported by each other by means of a roller bearing so that the two portions can be rotated relative to each other. The inner portion of the drive gear may be rotationally-fixed with respect to the drive shaft 1. A clutch is provided between the inner and outer portions of the drive gear 2, and when the clutch is engaged, the outer portion of the drive gear 2 becomes rotationally-fixed with respect to the inner portion of the drive gear so that the entire drive gear 2 is rotation-fixed relative to the drive shaft 1. The outer portion of the drive gear 2 can rotate freely when the clutch is disengaged. This structure may facilitate the engagement process and the disengagement process of the drive gear 2 and the driven gears 21.

In other embodiments, the axis of the drive gear 2 may be parallel to the axis of the drive shaft 1 but transversely offset therefrom, and the drive shaft 1 is in transmission connection with the drive gear 2 via a transmission mechanism such as, for example, a reduction transmission mechanism. The transmission mechanism together with the drive gear 2 as a whole, may be axially moved relative to the drive shaft 1, but is rotation-fixed relative to the drive shaft 1. For example, the transmission mechanism together with the drive gear 2 may be constructed as a gear set having a reduction transmission ratio, which comprises two, three or more gears.

In the embodiment shown in FIG. 1, the drive gear 2 can be axially moved to any position on the drive shaft 1, and can engaged with or disengaged from any one of the driven gears 21. The drive gear 2 and the driven gears 21 may be straight-toothed spur gears, respectively.

The drive gear 2 and the driven gears 21 may have an engagement assistant structure, whereby it is possible to more easily and more smoothly realize engagement therebetween. Next, explanation will further be made in more detail below with reference to FIGS. 5A and 5B.

The drive shaft 1 is connected to a drive motor 3, which may be mounted at a fixed position. Alternatively, the drive shaft 1 may have an interface for connection with the drive motor 3, and the drive motor 3 may be connected to the drive shaft 1 in an ex post manner. In this case, the drive motor 3 is not an inherent component of the actuator assembly. The drive motor 3 may be, for example, a DC motor or a stepper motor that can rotate in both directions.

As shown in FIG. 1, the actuator assembly includes a moving device 10 that is configured to axially move the drive gear 2 along the drive shaft 1 or in parallel to the drive shaft 1. Here, the moving device 10 is configured as a lead screw transmission, including a rotatably mounted lead screw 6 and a nut 5 that engages with the lead screw 6 and is translationally movable along the lead screw 6, wherein the nut 5 is configured to move the drive gear 2 axially on the drive shaft 1.

Here, the lead screw 6 has an axis that is parallel to that of the drive shaft 1. The nut 5 is fixedly connected with a sliding carriage 7 (i.e., the nut 5 and sliding carriage 7 may be two separate pieces that are joined together or may be constructed as a single piece).

As more clearly depicted in FIG. 2, the sliding carriage 7 may have a fork portion 7b that is configured to interact with opposed sides of the drive gear 2. The rotational movement of the drive gear 2 is not hindered by the fork portion 7b.

The sliding carriage 7 may be provided with a linear guide so that the sliding carriage 7 together with the nut 5 can perform a linear translational movement more smoothly. Here, the linear guide may include a channel 9 that is provided in a substrate 8 and a sliding member 7a (see FIG. 2) that is formed on the sliding carriage 7 and slidable in the channel 9.

The lead screw 6 is connected to an index motor 4 which is mounted at a fixed position. Alternatively, the lead screw 6 may have an interface for connection to the index motor 4, and the index motor 4 may be connected to the lead screw 6 in an ex post manner.

In this case, the index motor 4 is not an inherent component of the actuator assembly. The index motor 4 may be, for example, a DC motor or a stepper motor that can rotate in both directions.

The actuator assembly may further comprise a position sensor that is configured to directly or indirectly determine an axial position of the drive gear 2 on the drive shaft 1. By means of the position information determined by the position sensor, the index motor 4 may be controlled such that the drive gear 2 is accurately moved to a predetermined position on the drive shaft 1.

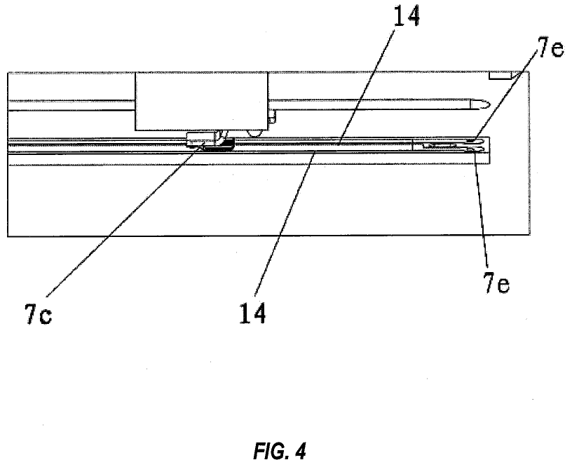

FIG. 4 is a partial top view of the actuator assembly according to FIG. 1 that illustrates an embodiment of the position sensor. The position sensor includes two conductive film strips 14 and a movable electrode 7c that may be in contact with the two conductive film strips 14. The electrode 7c follows an axial movement of the drive gear 2 on the drive shaft 1. On the end area of each of the two conductive film strips 14, a respective stationary electrode 7e may be connected, and the resistance value between the two electrodes 7e is related to the axial position of the drive gear 2 on the drive shaft 1, so that the axial position can be determined by the resistance value. The conductive film strips 14 and the stationary electrodes 7e may be mounted, for example, on the substrate 8. The electrode 7c may be disposed, for example, on the sliding carriage 7 (see FIG. 2).

Each actuator 20 may be provided with a locking device 30 that is shiftable between a locked state in which the position of the actuator 20 is fixed and an unlocked state in which the position of the actuator 20 may be adjusted. When the actuator 20 needs to be manipulated, the locking device 30 may be placed in the unlocked state. After the manipulation of the actuator 20 is completed, the locking device 30 may be placed in the locked state to prevent unintentional motion of the actuator 20.

FIG. 3 is a partial perspective view of the actuator assembly according to FIG. 1 that illustrates one example embodiment of the locking device 30. In this embodiment, the locking device 30 includes a claw 11 that is configured to engage with a tooth section of a driven gear 21 of a respective actuator 20, and biased by a spring 12 towards its engagement position. In FIG. 3, two of the locking devices 30 are illustrated. The drive gear 2 in the upper portion of FIG. 3 is engaged with the respective driven gear 21, and the locking device 30 is in its unlocked state where the claw 11 is pressed from its engagement position to its disengagement position. The locking device 30 in the lower portion of FIG. 3 is in its locked state where the claw 11 is returned to its engagement position by the spring element 12. The sliding carriage 7 may have a part 7d that interacts with each claw 11, wherein the part 7d may press a plate connected with the claw 11. The plate may have a slope 13, so that the part 7d easily slides onto and leaves from the plate. The slope may have a central apex. The curve shape of the slope is related to the engagement process and the disengagement process of the claw 11.

The actuator assembly may also include a planar substrate 8. Other components of the actuator assembly, such as the index motor 4, the lead screw 6, the drive motor 3, the drive shaft 1 and the drive gear 2, the actuators 20, and the like, may be mounted on the substrate 8. The components of the actuator assembly may be made of plastic as much as possible, whereby it is possible to achieve a favorable and stable PIM performance. However, components that are subjected to high loads may also be partially or completely made of a metal such as aluminum.

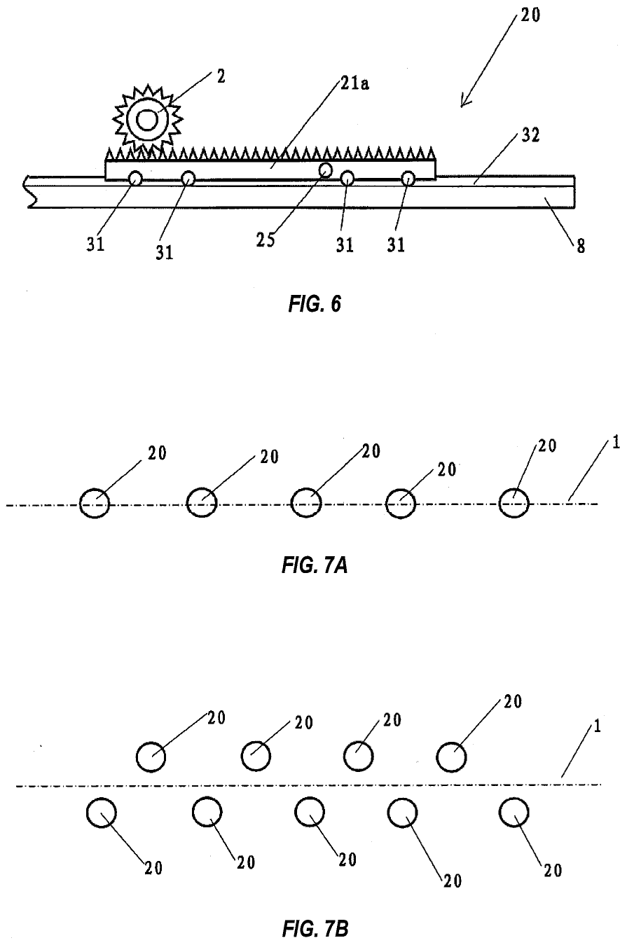

FIGS. 5A and 5B are two perspective views of a drive gear 2 for an actuator assembly, in accordance with an embodiment. It may be seen here that, each of the teeth 28 of the drive gear 2 may respectively have two end sections 28 that taper outwardly along an axial direction, as an engagement assistant structure. Each of the teeth of the driven gears 21 may also have such structure as an engagement assistant structure. In the case of driven racks 21a (see FIG. 6), the teeth of the driven racks may also have a similar structure. When the drive gear 2 is engaged with one of the driven gears 21 or one of the driven racks, the end sections that taper outwardly along the axial direction may guide a smooth engagement process.

While the depicted embodiment includes a drive gear 2 and driven gears 21 that are each implemented as spur gears, it will be appreciated that other types of gears may be used in other embodiments.

FIG. 6 is a partial schematic view of an actuator assembly according to another embodiment of invention. The embodiment illustrated in FIG. 6 is different from the embodiment illustrated in FIG. 1 mainly in that the actuators 20 are designed differently. Other components of the actuator assembly may be same or different from those in the embodiment in FIG. 1. FIG. 6 illustrates one of the actuators 20 in detail, where each actuator 20 includes a driven rack 21a, on both sides of which actuator elements 25 are fixed. Each driven rack 21a is associated with a channel 32 in a base plate 8. Each driven rack 21a can slide in the respective channel 32 along the respective channel 32. To reduce the friction between the driven racks 21a and the base plate 8, each driven rack 32 may be associated with a plurality of rollers 31. The driven racks 32 can be driven by a drive gear 2, so that the driven racks 32 can slide in the respective channels 32.

FIGS. 7A and 7B are exemplar schematic views of actuator arrangements. In FIG. 7A, a longitudinal axis of a drive shaft 1 is denoted by a broken line, and five actuators 20 are denoted by respective circles. The actuators 20 are arranged in a plane side by side and can be driven by a drive gear which is movable along the longitudinal axis of the drive shaft 1. The drive shaft 1 is arranged also in the same plane, so that the actuator assembly is flat as far as possible. In FIG. 7B, a longitudinal axis of a drive shaft 1 is denoted by a broken line, and nine actuators 20 are denoted by respective circles. Four of the actuators 20 are arranged in an upper plane side by side, and the other five actuators 20 are arranged in a lower plane side by side. All the actuators 20 can be driven by a drive gear which is movable along the longitudinal axis of the drive shaft 1. The drive shaft 1 is arranged between the upper plane and the lower plane the same plane in a height direction.

Finally, it is to be noted that, the above-described embodiments are merely for understanding the present invention but not constitute a limit on the protection scope of the present invention. For those skilled in the art, modifications may be made on the basis of the above-described embodiments, and these modifications do not depart from the protection scope of the present invention.

1. An actuator assembly for a base station antenna, comprising:
a plurality of actuators, and
a rotatably mounted drive shaft,
wherein the actuator assembly further comprises:
a drive gear configured to be axially movable relative to the drive shaft in order to engage with a selected one of the actuators.

2. The actuator assembly for a base station antenna according to claim 1, wherein each actuator includes a driven rack and an actuator element, and wherein the drive gear is configured to drive a selected one of the racks that is engaged with the drive gear.

3. The actuator assembly for a base station antenna according to claim 1, wherein each actuator includes a driven gear and an actuator element that is in transmission connection with the driven gear, and the drive gear is configured to drive a selected one of the driven gears that is engaged with the drive gear.

4.-5. (canceled)

6. The actuator assembly for a base station antenna according to claim 1, wherein the actuator assembly further comprises a moving device configured to axially move the drive gear relative to the drive shaft.

7. The actuator assembly for a base station antenna according to claim 1, wherein the drive gear is mounted on the drive shaft in an axially movable and rotation-fixed manner.

8.-9. (canceled)

10. The actuator assembly for a base station antenna according to claim 9, wherein at least one of the drive gear and the driven gears has at least one tooth which has one or two end sections that taper outwardly along an axial direction.

11. The actuator assembly for a base station antenna according to claim 6, wherein the moving device is configured as a lead screw transmission, including a lead screw that is rotatably mounted and a nut that engages with the lead screw and is translationally movable along the lead screw, wherein the nut is configured to move the drive gear axially relative to the drive shaft.

12. (canceled)

13. The actuator assembly for a base station antenna according to claim 1, wherein the actuator assembly further comprises a drive motor configured to drive the drive shaft, wherein the drive motor is mounted at a fixed position.

14. The actuator assembly for a base station antenna according to claim 11, wherein the actuator assembly further comprises an index motor configured to drive the lead screw, wherein the index motor is mounted at a fixed position.

15. The actuator assembly for a base station antenna according to claim 11, wherein the moving device includes a sliding carriage that is fixedly connected with the nut.

16. The actuator assembly for a base station antenna according to claim 15, wherein the sliding carriage has a fork portion that is configured to interact with both end sides of the drive gear.

17. The actuator assembly for a base station antenna according to claim 15, wherein the sliding carriage includes a sliding member which is slidable in a channel.

18. The actuator assembly for a base station antenna according to claim 1, wherein the actuator assembly comprises a position sensor configured to directly or indirectly determine an axial position of the drive gear relative to the drive shaft.

19. The actuator assembly for a base station antenna according to claim 18, wherein the position sensor includes two conductive film strips, a movable electrode member in contact with the two conductive film strips and two stationary electrode members respectively connected with one of the conductive film strips, wherein the movable electrode member follows an axial movement of the drive gear relative to the drive shaft.

20. (canceled)

21. The actuator assembly for a base station antenna according to claim 1, wherein each actuator is provided with a locking device shiftable between a locked state in which the actuator is fixed in place and an unlocked state in which the actuator is moveable.

22. The actuator assembly for a base station antenna according to claim 3, wherein each actuator is provided with a locking device shiftable between a locked state in which the actuator is fixed in place and an unlocked state in which the actuator is moveable, and the locking device includes a claw which is configured to engage with a tooth section of the driven gear of a respective actuator, and biased towards its engagement position, wherein when the drive gear engages with a respective driven gear, the claw is moved from its engagement position to its disengagement position, and when the drive gear disengages from the respective driven gear, the claw returns to its engagement position.

23. The actuator assembly for a base station antenna according to claim 22, wherein the actuator assembly further comprises a moving device configured to axially move the drive gear relative to the drive shaft;
wherein the moving device is configured as a lead screw transmission, including a lead screw that is rotatably mounted and a nut that engages with the lead screw and is translationally movable along the lead screw, wherein the nut is configured to move the drive gear axially relative to the drive shaft,
wherein the moving device includes a sliding carriage that is fixedly connected with the nut,
wherein the sliding carriage has a part interacted with the claw, wherein the part is configured to: move the claw from its engagement position to its disengagement position when the drive gear engages with a respective driven gear, and leave the claw so that the claw returns its engagement position when the drive gear disengages from the respective driven gear.

24. (canceled)

25. The actuator assembly for a base station antenna according to claim 1, wherein each actuator is constructed as a linear actuator, wherein an actuator element of the actuator moves in a linearly translatable manner, and wherein the actuator element of each actuator is configured to couple with a wiper arm of a phase shifter assembly.

26. The actuator assembly for a base station antenna according to claim 25, wherein each actuator includes a lead screw transmission, including a lead screw that is rotatably mounted and in transmission connection with the drive gear and a nut that is translationally movable in engagement with the lead screw and fixedly connected with the actuator element.

27.-31. (canceled)

32. The actuator assembly for a base station antenna according to claim 1, wherein
all the actuators are arranged in parallel with each other in one plane; or
all the actuators are arranged in parallel with each other in two planes, with the actuators in one of the planes staggered relative to the actuators in the other of the planes.

33.-34. (canceled)
